(19) United States
(12) Patent Application Publication
(10) Pub. No.: US 2008/0026753 A1
(43) Pub. Date: Jan. 31, 2008

(54) MOBILE COMMUNICATION SYSTEM AND COMMUNICATION LINE SWITCHING METHOD IN THE MOBILE COMMUNICATION SYSTEM

(75) Inventors: Masanori OKINOI, Kanagawa (JP); Hiroki SHINDE, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/460,716

(22) Filed: Jul. 28, 2006

(51) Int. Cl. H04Q 7/20

(52) U.S. Cl. 455/436

(57) ABSTRACT

A mobile communication system and communication line switching method in the mobile communication system capable of selecting the communication line, if there is a communication line with a better condition than the current communication line. If there is a communication-possible range with a better condition than a communication-possible range of a communication carrier that currently provides a communication line to mobile telephone 102, a communication carrier that provides a communication line to the communication-possible range is selected to enable communication under management of this communication carrier. By this means, it is possible to select a carrier or service area with a better condition than the currently used carrier or service area in terms of usage rate or service and achieve improvement of user convenience.

### BACKGROUND OF THE INVENTION

1. Field of the Invention

The present invention relates to a mobile communication system having a mobile terminal and a management server apparatus that controls a base station communicating with the mobile terminal, and a communication line switching method in the mobile communication system.

2. Description of the Related Art

Conventionally, in a mobile communication system such as a mobile telephone, once communication starts, communication is performed within the communication-possible range (referred to as “service area”) of a carrier contracted in advance

In this case, even if the communication fee of the telecommunication carrier is high, a user must pay the contracted fee. As a means for avoiding this, a technology for automatically selecting and switching to an inexpensive line has been proposed. For example, refer to Patent Document 1: BT group, “automatically switching lines between a mobile telephone outside and a fixed line at home,” Nihon Keizai Shimbun, May 19th, 2004, evening edition.

However, in the conventional mobile communication system, although it is possible to automatically select an inexpensive line, there is still a problem that, even if a communication line with a good condition is available, only if the user moves a little, the user cannot use this.

### SUMMARY OF THE INVENTION

It is therefore an object of the present invention to provide a mobile communication system and a communication line switching method in the mobile communication system capable of selecting the communication line, if there is a communication line with a better condition than the current communication line.

According to an aspect of the invention, the mobile communication system of the present invention has a mobile terminal and a management server apparatus that controls a base station communicating with the mobile terminal, wherein, when there is a communication-possible range with a better condition than the communication-possible range of a communication carrier that currently provides a communication line to the mobile terminal, the management server apparatus selects a communication carrier that provides a communication line to the communication-possible range, and, under management of this communication carrier, enables communication.

According to another aspect of the invention, in the mobile communication system of the present invention, the management server apparatus controls a wireless LAN base station connected to a network, a base station connected via another network, or a terrestrial base station of an artificial satellite

### BRIEF DESCRIPTION OF THE DRAWINGS

The above and other objects and features of the invention will appear more fully hereinafter from a consideration of the following description taken in connection with the accompanying drawings in which:

FIG. 1 is a schematic view showing the mobile communication system in use according to an embodiment of the present invention;

FIG. 2 is an enlarged view of a screen displayed in the display section of the mobile telephone in FIG. 1;

FIG. 3 is a view showing a service request button provided on the mobile telephone in FIG. 1;

FIG. 4 is a view showing an example of a message displayed in the display section of the mobile telephone in FIG. 1;

FIG. 5 is a view showing a case of outside the service area of the mobile telephone in a conventional usage mode;

FIG. 6 is a schematic view showing a case in which communication is performed using a wireless LAN base station in the mobile communication system in FIG. 1;

FIG. 7 is a schematic view showing a case in which communication is performed using an artificial satellite in the mobile communication system in FIG. 1;

FIG. 8 is a view showing a schematic configuration of the management server apparatus in the mobile communication system in FIG. 1;

FIG. 9 is a view showing a schematic configuration of the service area terminal management server in FIG. 8;

FIG. 10 is a view showing an example of a record of the service area terminal management database in FIG. 9;

FIG. 11 is a view showing a schematic configuration of the other-carrier terminal management server in FIG. 8;

FIG. 12 is a view showing an example of a record of the other-carrier terminal management database in FIG. 11;

FIG. 13 is a view showing the schematic configuration of the charging server in FIG. 8;

FIG. 14 is a view showing an example of a record of the time charging database in FIG. 13;

FIG. 15 is a view showing an example of a record of the location charging database in FIG. 13;

FIG. 16 is a view showing an example of a record of the number of uses charging database in FIG. 13;

FIG. 17 is a view showing an example of a record of the flat rate charging database in FIG. 13;

FIG. 18 is a view showing an example of a record of the communication method charging database in FIG. 13;

FIG. 19 is a view showing an example of a record of the communication speed charging database in FIG. 13;

FIG. 20 is a view showing an example of a record of the information type charging database in FIG. 13;

FIG. 21 is a view showing an example of a record of the charging database in FIG. 13;

FIG. 22 is a view showing a processing sequence of the management server apparatus in the mobile communication system in FIG. 1;

FIG. 23 is a flowchart showing a processing of the mobile telephone in the mobile communication system in FIG. 1;

FIG. 24 is a flowchart showing a processing of the base station in the mobile communication system in FIG. 1;

FIG. 25 is a flowchart showing a processing of the service area terminal management server in FIG. 8;

FIG. 26 is a flowchart showing a processing of the charging server in FIG. 8;

FIG. 27 is a view showing a processing sequence of the management server apparatus in the mobile communication system in FIG. 1;

FIG. 28 is a flowchart showing a processing when the mobile telephone in the mobile communication system in FIG. 1 operates as a relay terminal;

FIG. 29 is a flowchart showing a processing of other-carrier terminal management server in FIG. 8;

FIG. 30 is a view illustrating a first usage fee payment method in the mobile communication system in FIG. 1;

FIG. 31 is a view illustrating a second usage fee payment method in the mobile communication system in FIG. 1; and

FIG. 32 is a view illustrating a third usage fee payment method in the mobile communication system in FIG. 1.

### DESCRIPTION OF THE PREFERRED EMBODIMENT

Embodiments of the present invention will be explained below in detail with reference to the accompanying drawings.

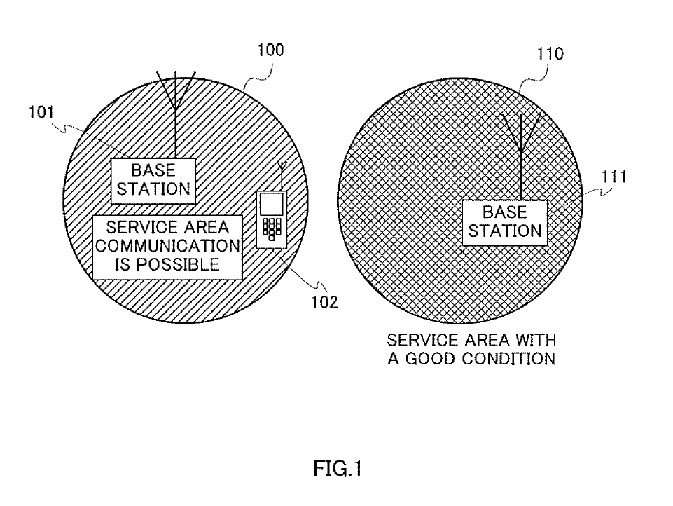

FIG. 1 is a schematic view showing the mobile communication system in use according to an embodiment of the present invention. The figure illustrates a case where mobile telephone 102 that is one of user mobile terminals is located within communication-possible range (hereinafter, referred to as “service area”) 100 of base station 101 of the communication carrier and where there is service area 110 with a better condition than service area 100. In addition, service area 110 is a service area of base station 111. The mobile communication system of this embodiment has a function of reporting the presence of service area 110 besides service area 100, to mobile telephone 102.

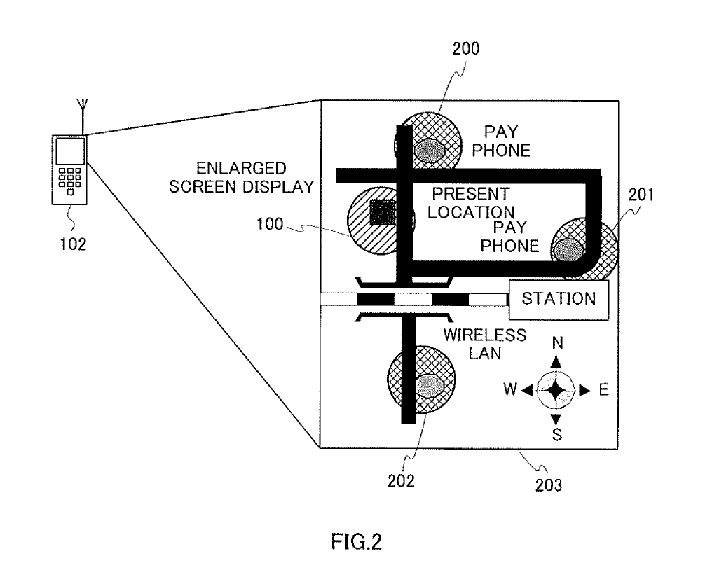

FIG. 2 is an enlarged view of screen 203 displayed in the display section of mobile telephone 102. In this figure, in screen 203 of mobile telephone 102, current service area 100 of mobile telephone 102, service area 200 and service area 201 with pay phones at center, and wireless LAN (Local Area Network) service area 202, are displayed.

When the user can communicate with a better condition in service area 200 or service area 201 with a pay phone at center, or in wireless LAN service area 202, than in current service area 100 of mobile telephone 102, information for using these areas is displayed in enlarged screen 203.

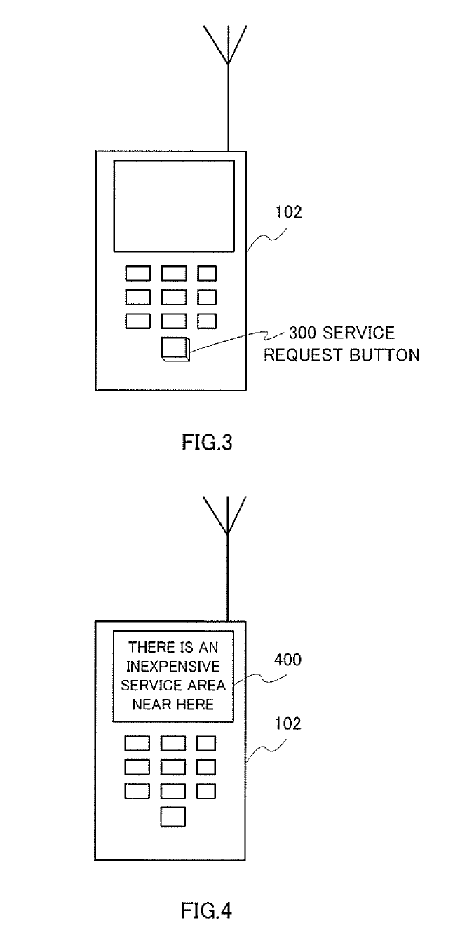

By checking the information, the user of mobile telephone 102 can move to service area where communication is possible with a better condition and communicate. This display is implemented by a microcomputer (not shown) of mobile telephone 102 based on information from a management server apparatus managing mobile telephone 102. In this case, the screen shown in FIG. 2 is displayed when the user of mobile telephone 102 operates service request button 300 provided on mobile telephone 102 as shown in FIG. 3.

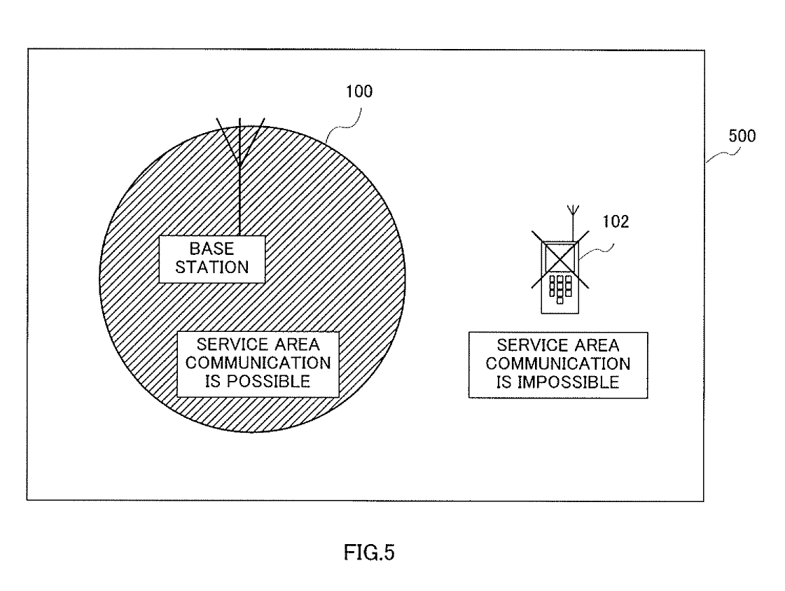

In addition, if there is a service area with a better condition than the current service area, as shown in FIG. 4, it is also possible to display information reporting that fact on screen 400 of mobile telephone 102. By this means, as shown in FIG. 5, the mobile communication system is also effective in the case in which mobile telephone 102 is located in outside area 500 for service area 100, and mobile telephone 102 cannot obtain enlarged screen 203 or screen 400 of mobile telephone 102. Furthermore, in such a case, if communication is possible with another mobile telephone located in nearby service area 110, it is possible to obtain location information or screen through that mobile telephone.

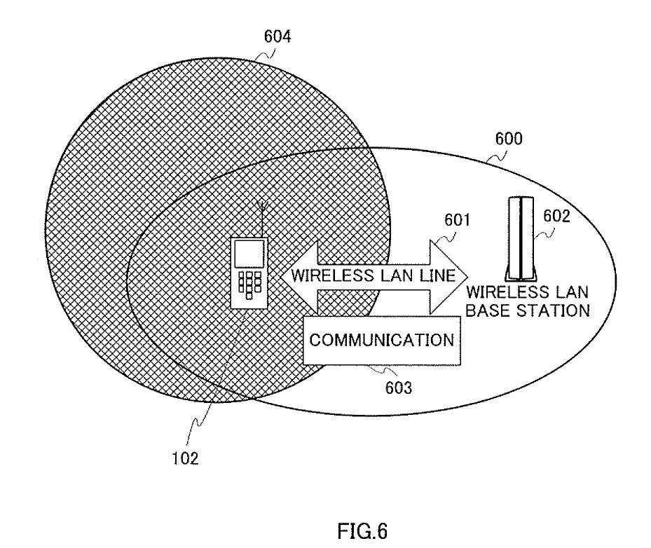

Furthermore, as shown in FIG. 6, when mobile telephone 102 is located in service area 604 and also in service area 600 with a good condition with wireless LAN base station 602 at center, mobile telephone 102 can perform communication 603 through wireless LAN line 601. In this case, mobile telephone 102 needs to be provided with a wireless LAN function to use wireless LAN line 601.

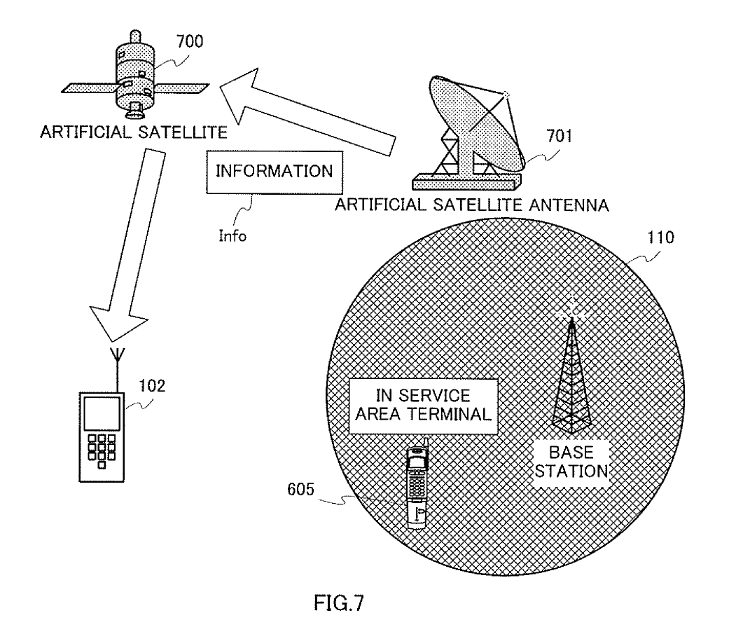

Furthermore, if there is no other mobile telephone in service area 110 near mobile telephone 102, as shown in FIG. 7, it is possible to obtain information about nearby service area 110 or information Info about service area terminal 605 located in service area 110 through terrestrial artificial satellite antenna 701 and artificial satellite 700.

### In this case, mobile telephone 102 needs to be provided with a communication function to use artificial satellite 700.

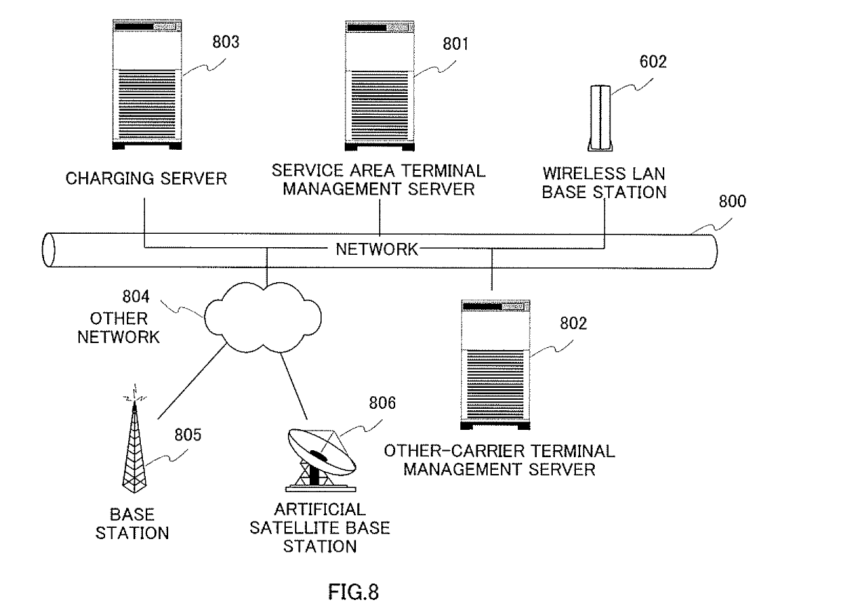

The mobile communication system of this embodiment has base station 101 of communication-possible range 100, base station 111 of communication-possible range 110, mobile telephone 102 of the user, and a management server apparatus shown in FIG. 8, and details of these will be explained below.

FIG. 8 is a view showing a schematic configuration of the management server apparatus. In this figure, the management server apparatus is configured with service area terminal management server 801 that is connected through network 800, other-carrier terminal management server 802 and charging server 803. These servers 801 to 803 forming the management server apparatus control wireless LAN base station 602 that is connected to network 800, base station 805 that is connected via an other network 804, and artificial satellite base station 806.

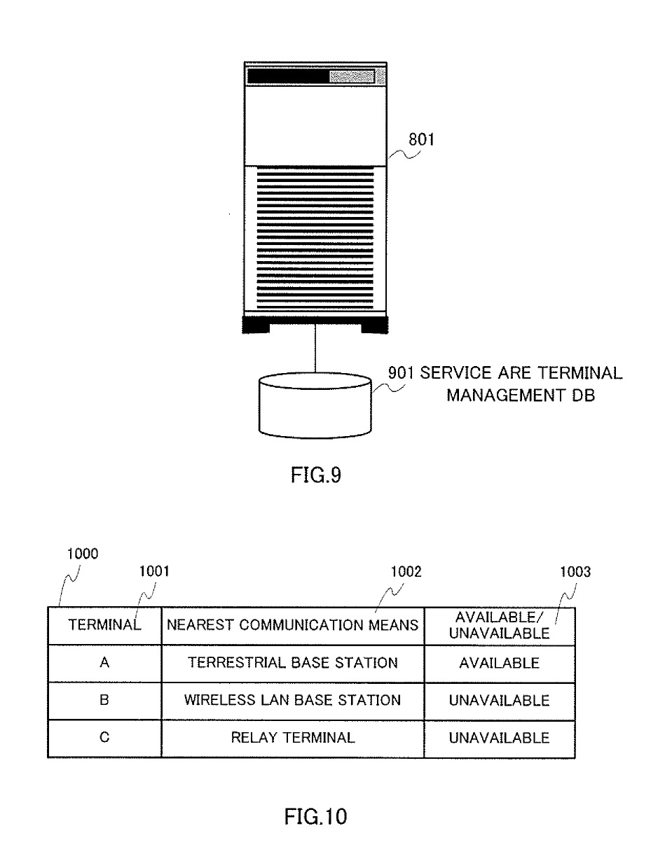

Service area terminal management database 901 shown in FIG. 9 is connected to service area terminal management server 801. FIG. 10 is an example of service area terminal management database record 1000 of service area terminal management database 901. This service area terminal management database record 1000 is made up of terminal record 1001, or nearest communication means 1002, available/unavailable 1003, and the row for terminal A indicates that a terrestrial base station is the nearest communication means and is available. The row for terminal B indicates that a wireless LAN base station is the nearest communication means and is unavailable. The row for terminal C indicates that a relay terminal is the nearest communication means and is unavailable.

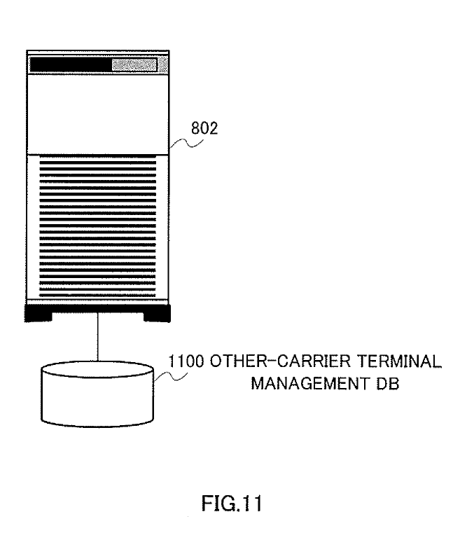

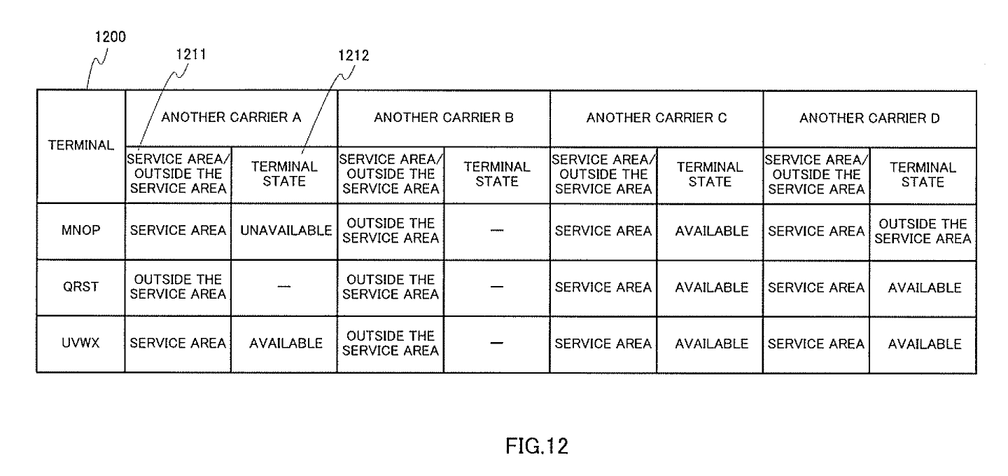

Other-carrier terminal management database 1100 shown in FIG. 11 is connected to other-carrier terminal management server 802. FIG. 12 is an example of other-carrier terminal management database record 1200 of other-carrier terminal management database 1100. Other-carrier terminal management database record 1200 is made up of record 1211 that determines whether terminal type MNOP, QRST or UVWX is in the service area of another carrier A, another carrier B, another carrier C or another carrier D, and terminal state 121 when the terminals are in the service areas. For example, in the case of terminal MNOP, it is indicated that terminal MNOP is in the service area of another carrier A, but terminal state 1212 indicates “unavailable.”

Furthermore, in the case of terminal QRST, it is indicated that terminal QRST is outside the service area of another carrier A, and in that case, it is possible to record available, unavailable or nothing can be recorded in terminal state 1212.

### Furthermore, in the case of terminal UVWX, it is indicated that terminal UVWX is in the service area of another carrier A, and terminal state 1212 indicates “available.”

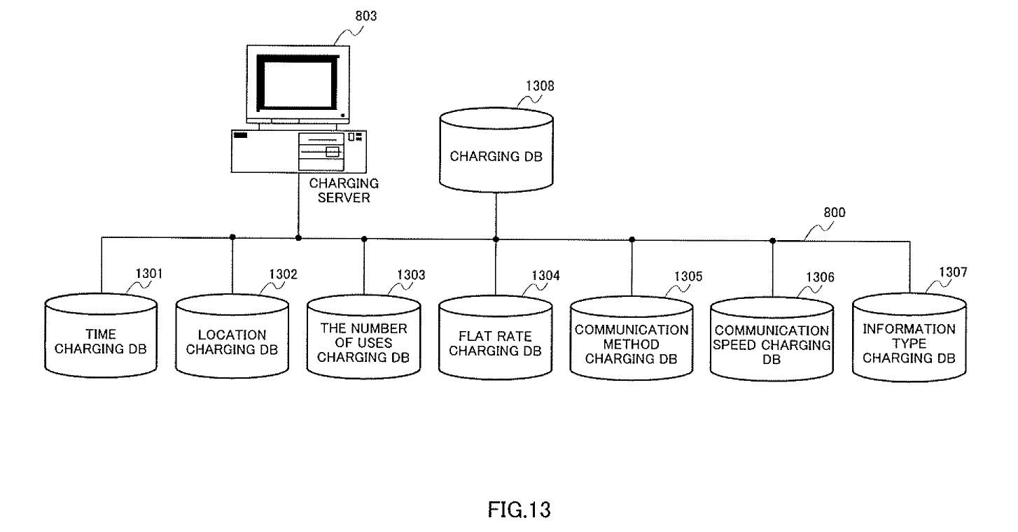

Charging server 803 has time charging database 1301, location charging database 1302, the number of uses charging database 1303, flat rate charging database 1304, communication method charging database 1305, communication speed charging database 1306 and information type charging database 1307, or a configuration combining some of these, and charging database 1308, that are connected by network 800 shown in FIG. 13.

FIG. 14 is an example of time charging database record 1400 of time charging database 1301. Time charging database record 1400 is made up of charging method 1405 and rate 1406. For example, charging method A charges 10 yen per second of use. Charging method B charges 50 yen per minute of use.

Charging method C charges 100 yen per hour of use. Charging method D charges 10 yen per minute of use after 24 hours.

In addition, a charging method combining charging method A, charging method B, charging method C and charging method D, is possible. In this case, rate 1406 charged by combining the above methods may be contracted between the user and the carrier, and a rate other than the above described rates is possible.

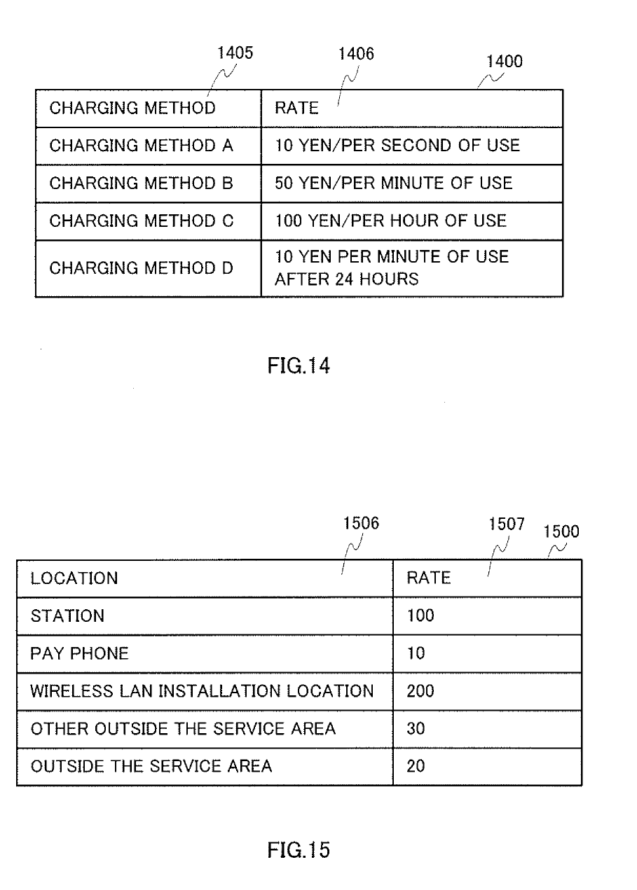

FIG. 15 is an example of record 1500 of location charging database 1302. Location charging database record 1500 is made up of location 1506 and rate 1507, and is a record for charging according to location 1506 where the terminals are used. For example, when location 1506 is a station, 100 yen is charged. When location 1506 is a pay phone, 10 yen is charged. When location 1506 is wireless LAN installation location, 200 yen is charged. When location 1506 is another service area, 30 yen is charged. When location 1506 is outside the service area, 20 yen is charged.

In addition, charging may be implemented by combining the above methods. In this case, rate 1507 charged by combining the above methods may be contracted between the user and the carrier, and a rate other than the above described rates is possible.

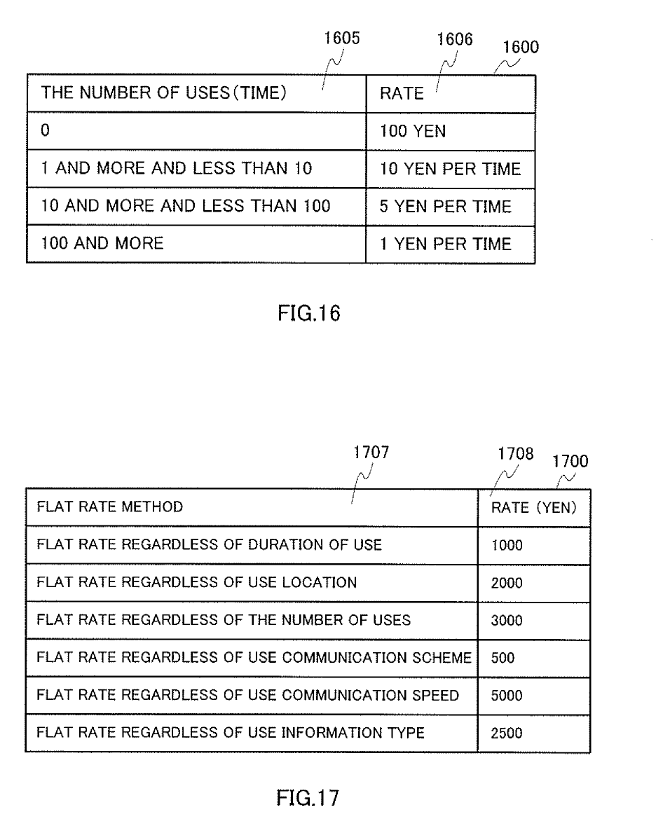

FIG. 16 is an example of record 1600 of the number of uses charging database 1303. The number of uses charging database record 1600 is made up of the number of uses 1605 and rate 1606, and is a record for charging according to the number of uses 1605. For example, when the number of uses 1605 is zero, 100 yen is charged. When the number of uses 1605 is one or more and less than ten, 10 yen per use is charged. When the number of uses 1605 is ten or more and less than a hundred, 5 yen per use is charged. When the number of uses 1605 is a hundred or more, 1 yen per use is charged.

In addition, charging may be implemented by combining the above methods. In this case, whether charging may be implemented by combining the above methods may be contracted between the user and the carrier, and a rate other than the above described rates is possible.

FIG. 17 is an example of record 1700 of flat rate charging database 1304. Flat rate charging database record 1700 is made up of flat rate method 1707 and rate 1708, and is a record for charging according to flat rate method 1707. For example, the methods include a method of charging 1000 yen when flat rate method 1707 is a flat rate regardless of time, a method of charging 2000 yen in the case of a flat rate regardless of location, a method of charging 3000 yen in the case of a flat rate regardless of the number of uses, a method of charging 500 yen in the case of a flat rate regardless of a communication scheme, a method of charging 5000 yen in the case of a flat rate regardless of communication speed and a method of charging 2500 yen in the case of a flat rate regardless of information type.

In addition, charging may be implemented by combining the above methods. Rate 1708 charged by combining the above methods may be contracted between the user and the carrier, and a rate other than the above described rates is possible.

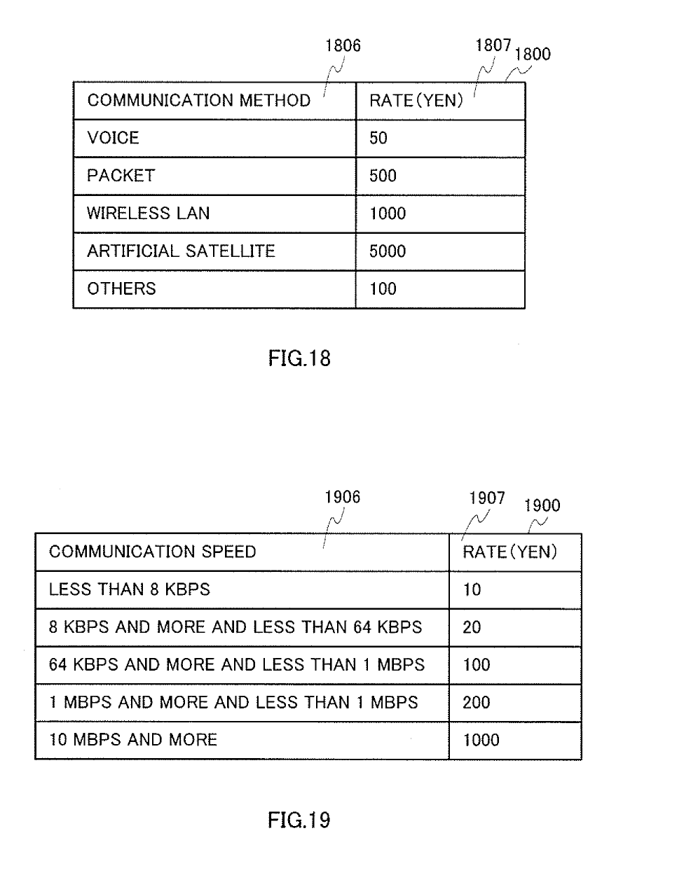

FIG. 18 is an example of communication method charging database record 1800 of communication method charging database 1305. Communication method charging database record 1800 is made up of communication method 1806 and rate 1807, and is a record for charging according to communication method 1806.

For example, the methods include a method of charging 50 yen when communication method 1806 is voice, a method of charging 500 yen in the case of a packet, a method of charging 1000 yen in the case of wireless LAN, a method of charging 5000 yen in the case of an artificial satellite and a method of charging 100 yen in other cases.

In addition, charging may be implemented by combining the above methods. Rate 1807 charged by combining the above methods may be contracted between the user and the carrier, and a rate other than the above described rates is possible.

FIG. 19 is an example of communication speed charging database record 1900 of communication speed charging database 1306. Communication speed charging database record 1900 is made up of communication speed 1906 and rate 1907, and is a record for charging according to communication speed 1906.

For example, the methods include a method of charging 10 yen when communication speed 1906 is less than 8 kbps, a method of charging 20 yen in the case of 8 kbps or more and less than 64 kbps, a method of charging 100 yen in the case of 64 kbps or more and less than 1 Mbps, a method of charging 200 yen in the case of 1 Mbps or more and less than 10 Mbps and a method of charging 1000 yen in the case of 10 Mbps or more.

In addition, charging may be implemented by combining the above methods. Rate 1907 charged by combining the above methods may be contracted between the user and the carrier, and a rate other than the above described rates is possible.

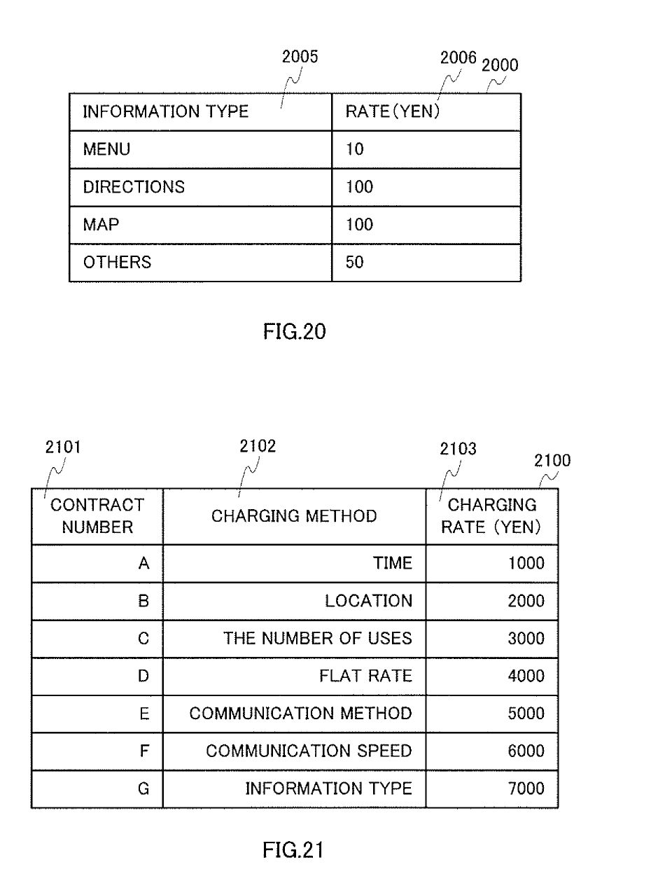

FIG. 20 is an example of information type charging database record 2000 of information type charging database 1307. Information type charging database record 2000 is made up of information type 2005 and rate 2006, and is a record for charging according to information type 2005. For example, the methods include a method of charging 10 yen when information type 2005 is menu, a method of charging 100 yen in the case of directions, a method of charging 100 yen in the case of a map and a method of charging 50 yen in other cases.

In addition, charging may be implemented by combining the above methods. Rate 2006 charged by combining the above methods may be contracted between the user and the carrier, and a rate other than the above described rates is possible.

FIG. 21 is an example of charging database record 2100 of charging database 1308. Charging database record 2100 is made up of contract number 2101, charging method 2102 and charging rate 2103, and manages charging according to contract number 2101. For example, contract number A indicates that charging method 2102 is determined by duration of use and charging rate 2103 is 1000 yen, contract number B indicates that charging method 2102 is determined by location and charging rate 2103 is 2000 yen, contract number C indicates that charging method 2102 is determined by the number of uses and charging rate 2103 is 3000 yen, contract number D indicates that charging method 2102 is determined by flat rate and charging rate 2103 is 4000 yen, contract number E indicates that charging method 2102 is determined by communication method and charging rate 2103 is 5000 yen, contract number F indicates that charging method 2102 is determined by communication speed and charging rate 2103 is 6000 yen, and contract number C indicates that charging method 2102 is determined by information type and charging rate 2103 is 7000 yen.

In addition, the above described charging methods are only examples, and charging method 2102 combining the above methods and configurations other than the configurations described here are possible.

Furthermore, charging may be implemented by combining the charging methods described in FIG. 14 to FIG. 21.

Next, an operation of the mobile communication system of this embodiment will be explained.

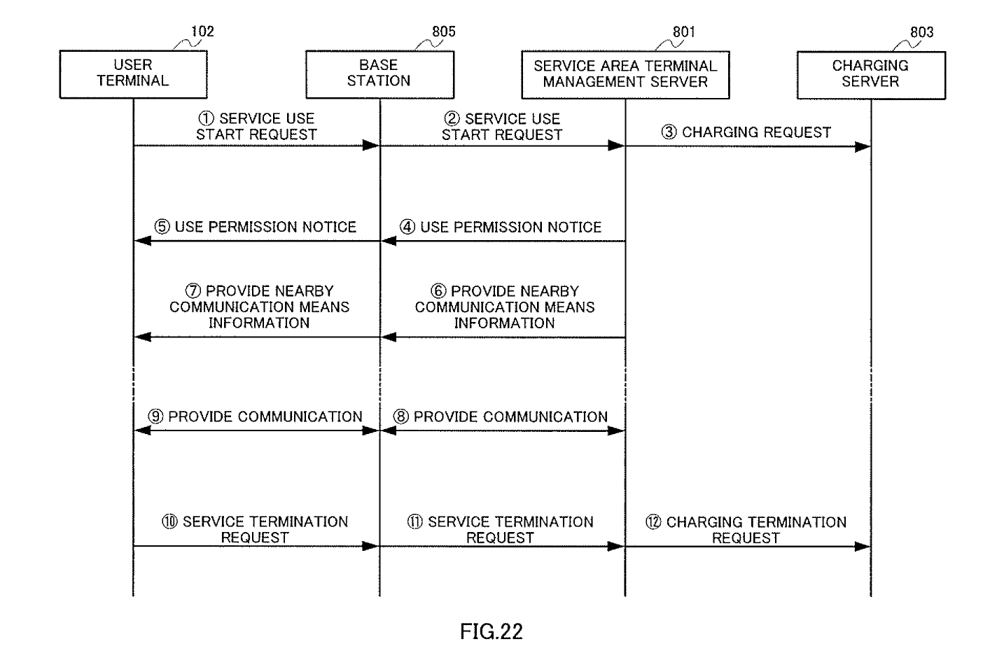

FIG. 22 is a processing sequence of a management server apparatus when mobile telephone 102 of the user is located in the service area of the contracted carrier. In this figure, mobile telephone 102 of the user transmits a service use start request to base station 805. Upon receiving the service use start request, base station 805 transmits the service use start request to service area terminal management server 801. Service area terminal management server 801 transmits a charging start request to charging server 803 to start charging. Furthermore, service area terminal management server 801 transmits a use permission notice to base station 805. Upon receiving the use permission notice, base station 805 transmits the use permission notice to mobile telephone 102 of the user.

Next, service area terminal management server 801 provides nearby communication means information to base station 805, and base station 805 provides nearby communication means information to mobile telephone 102 of the user. Then, when mobile telephone 102 of the user starts communicating with the communication means reported by the provision of the communication means information, service area terminal management server 801 provides communication to base station 805, and base station 805 provides nearby communication to mobile telephone 102 of the user. When communication is completed, mobile telephone 102 issues a service termination request to base station 805. Base station 805 transmits a service termination request to service area terminal management server 801. Service area terminal management server 801 issues a charging termination request to charging server 803 and finishes a series of service.

Next, processing of mobile telephone 102 of the user, base station 805, service area terminal management server 801 and charging server 803 in the service area will be explained using flowcharts.

(Mobile Telephone 102)

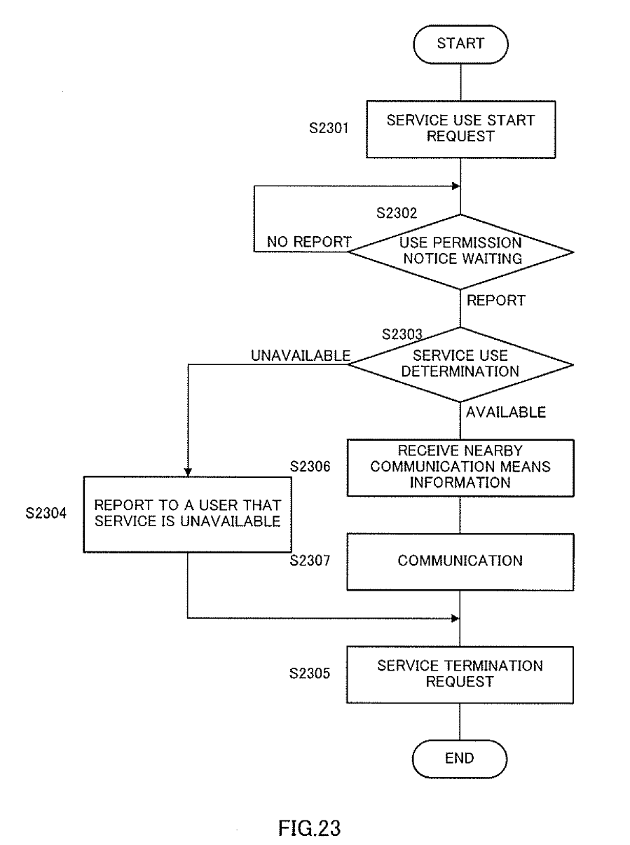

FIG. 23 is a flowchart showing a processing of mobile telephone 102. In this figure, mobile telephone 102 issues a service use start request to start service (step S2301).

Mobile telephone 102 receives a use permission notice from base station 805 (step S2302). When receiving the use permission notice, mobile telephone 102 determines whether or not service is available (step S2303). If service is not available, mobile telephone 102 reports to the user that service is not available (step S2304) and issues a service termination request (step S2305). On the other hand, if service is available, mobile telephone 102 receives provision of nearby communication means information (step S2306), and displays nearby communication means information in enlarged screen 203 in FIG. 2 or screen 400 in FIG. 4. After that, mobile telephone 102 performs communication when mobile telephone 102 is in the service area of the communication means that the user desires (step S2307).

### When communication is finished, mobile telephone 102 issues a service termination request (step S2305), and finishes the processing.

(Base Station 805)

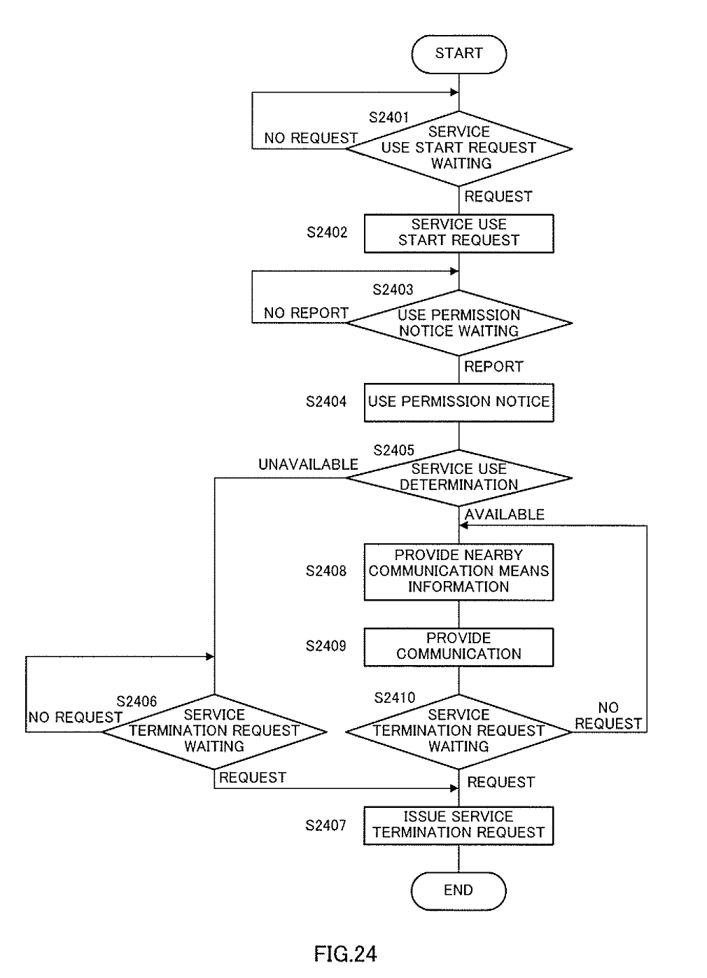

FIG. 24 is a flowchart showing a processing of base station 805. In this figure, base station 805 performs the processing of waiting for a service use start request from mobile telephone 102 (step S2401). When base station 805 receives the service use start request, issues a service use start request to service area terminal management server 801 (step S2402). Next, base station 805 performs reception processing of the use permission notice from service area terminal management server 801 (step S2403).

Upon reception of the use permission notice, base station 805 issues a use permission notice to mobile telephone 102 (step S2404). Base station 805 performs determination processing on the content of the use permission notice received from service area terminal management server 801 (step S2405). If service is not available, base station 805 waits for a service termination request (step S2406). If the service termination request is issued, base station 805 issues a service termination request to service area terminal management server 801 (step S2407), and finishes the processing. If service is available, base station 805 provides nearby communication means information (step S2408). Then, base station 805 provides communication (step S2409). Base station 805 performs processing of waiting for a service termination request from mobile telephone 102 (step S2410). If the service termination request is issued, base station 805 issues a service termination request to service area terminal management server 801 (step S2407), and finishes the processing.

(Service Area Terminal Management Server 801)

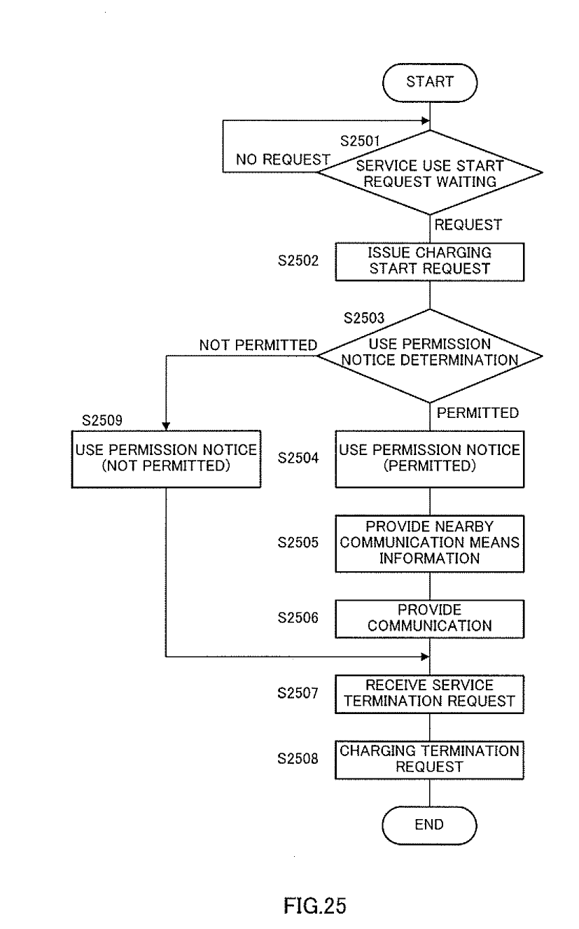

FIG. 25 is a flowchart showing a processing of service area terminal management server 801. In this figure, mobile telephone 102 in the service area performs processing of waiting for a service use start request from base station 805 (step S2501). When the service start request is issued from base station 805, service area terminal management server 801 issues a charging start request to charging server 803 (step S2502). Next, service area terminal management server 801 performs use permission notice determination processing for base station 805 (step S2503), and issues a use permission notice (not permitted) (step S2509) or a use permission notice (permitted) (step S2504). In the case of a use permission notice (permitted), service area terminal management server 801 provides nearby communication means information (step S2505) and then provides communication (step S2506). When service area terminal management server 801 performs reception processing of a service termination request from base station 805 (step S2507), issues a charging termination request to charging server 803 (step S2508), and finishes the processing. On the other hand, in the determination of the above step S2503, in the case of a use permission notice (not permitted) after performing reception processing of the service termination request from base station 805 (step S2507) service area terminal management server 801 issues a charging termination request to charging server 803 (step S2508), and finishes the processing.

(Charging Server 803)

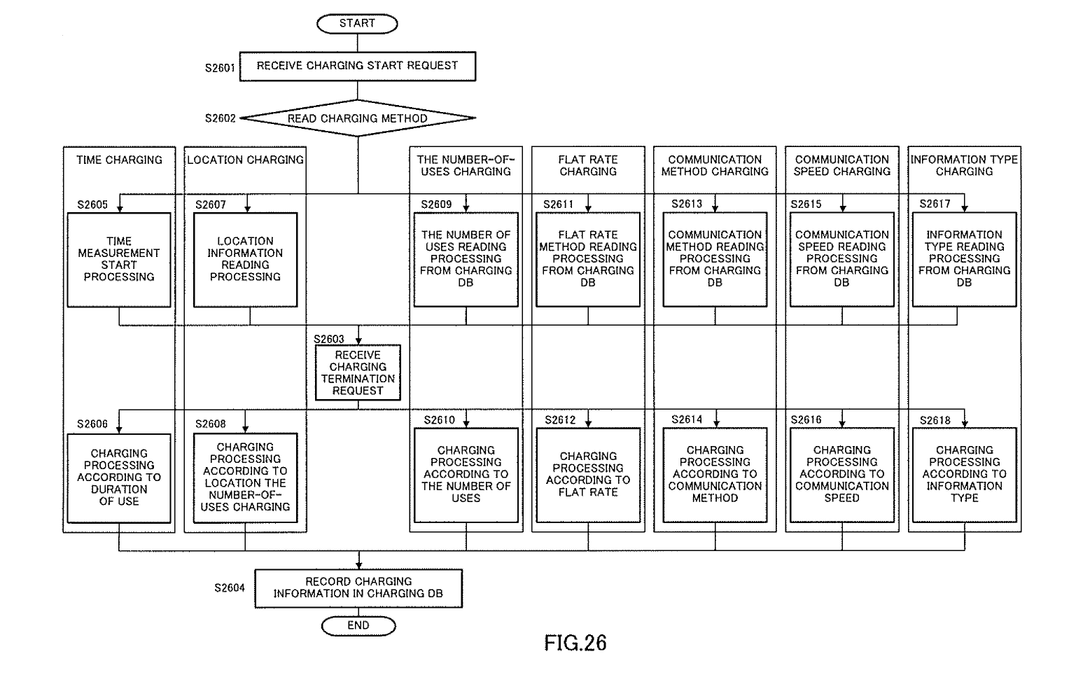

FIG. 26 is a flowchart showing a processing of charging server 803. In this figure, charging server 803 performs reception processing of a charging start request from service area terminal management server 801 (see FIG. 8) (step S2601).

Then, charging server 803 starts charging processing according to the contracted method recorded in record 2100 (see FIG. 2) of charging database 1308 (see FIG. 13), and firstly reads the charging method (step S2602). As a result, charging server 803 performs time measurement start processing (step S2605) in the case of time charging, location information reading processing (step S2607) in the case of location charging, the number-of-uses reading processing (step S2609) from charging database 1308 in the case of the number-of-uses charging, flat rate reading processing (step S2611) from charging database 1308 in the case of flat rate charging, communication method reading processing (step S2613) from charging database 1308 in the case of communication method charging, communication speed reading processing (step S2615) from charging database 1308 in the case of communication speed charging, information type reading processing (step S2617) from charging database 1308 in the case of information type charging.

Charging server 803 performs reception processing (step S2603) of a charging termination request (see FIG. 22) from service area terminal management server 801, and performs charging processing according to duration of use (step S2606) in the case of time charging, charging processing according to location (step S2608) in the case of location charging, charging processing according to the number of uses (step S2610) in the case of the number of uses charging, charging processing according to a flat rate (step S2612) in the case of flat rate charging, charging processing according to communication method (step S2614) in the case of communication method charging, charging processing according to communication speed (step S2616) in the case of communication speed charging, charging processing according to information type (step S2618) in the case of information type charging. Then, charging server 803 records the charging processing results in charging database 1308 as charging information (step S2604).

Next, processing of mobile telephone 102 of the user, base station 80S, service area terminal management server 801 and charging server 803 outside the service area will be explained.

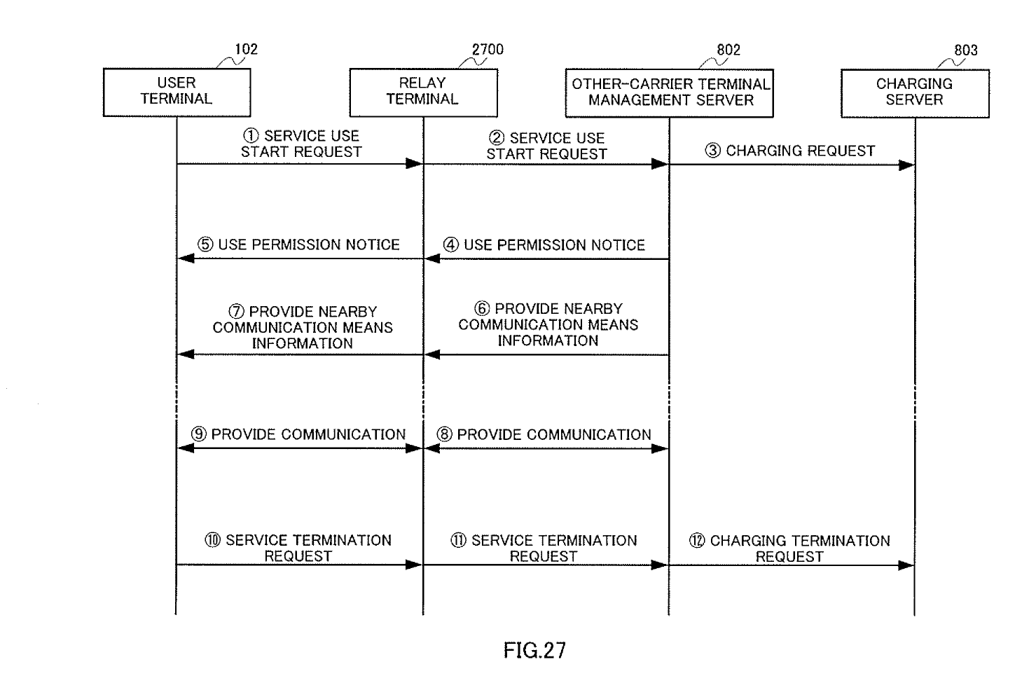

FIG. 27 is a sequence view showing a processing of the management server when mobile telephone 102 of the user is outside the service area of a contracted carrier, but is in the service area of another carrier terminal capable of relaying communication. In this figure, mobile telephone 102 of the user transmits a service use start request. Relay terminal 2700 receives a service use start request and issues a service use start request to other-carrier terminal management server 802. Other-carrier terminal management server 802 issues a charging start request to charging server 803 to start charging, and also issues a use permission notice to relay terminal 2700.

Relay terminal 2700 receives a use permission notice and issues a use permission notice to mobile telephone 102 of the user. Then, other-carrier terminal management server 802 provides nearby communication means information or communication to relay terminal 2700, and relay terminal 2700 provides nearby communication means information and communication to mobile telephone 102. When communication is completed, mobile telephone 102 issues a service termination request to relay terminal 2700. Relay terminal 2700 issues a service termination request to other-carrier terminal management server 802. Other-carrier terminal management server 802 issues a charging termination request to charging server 803 and finishes a series of service.

Next, processing of relay terminal 2700 and other-carrier terminal management server 802 will be explained using flowcharts.

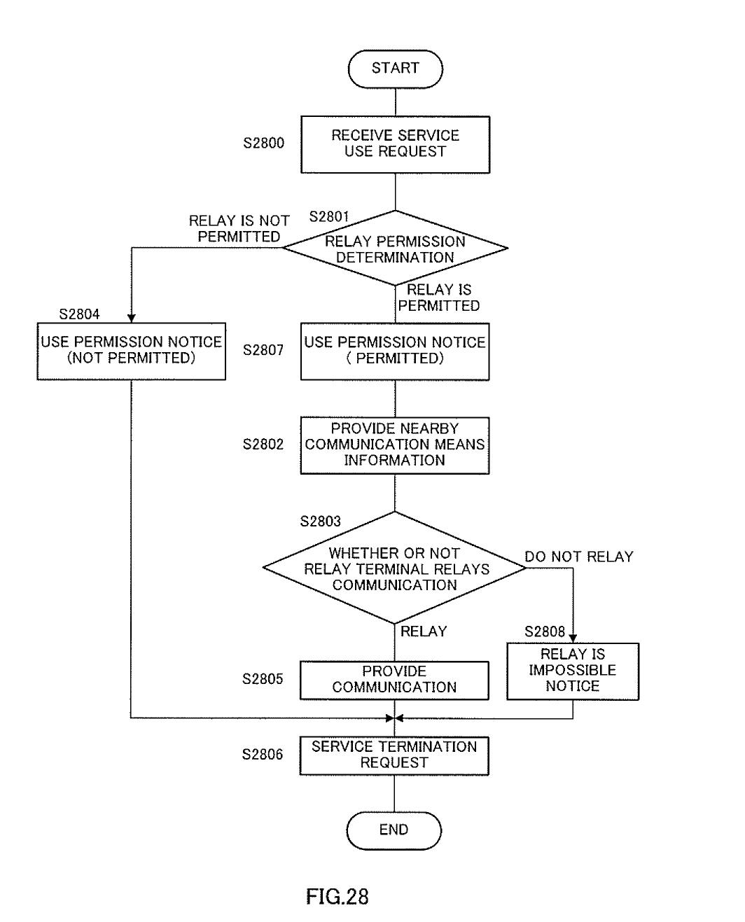

FIG. 28 is a flowchart showing a processing of relay terminal 2700. In this figure, relay terminal 2700 performs reception processing (step S2800) of a service use start request from mobile telephone 102 of the user and determination processing (step S2801) of determining whether or not to relay communication. When relay is not possible, relay terminal 2700 performs processing of reporting a use permission notice (not permitted) to mobile telephone 102 of the user (step S2804).

Then, relay terminal 2700 issues a service termination request to other-carrier terminal management server 802 (step S2806), and finishes the processing. When relay is possible, relay terminal 2700 performs processing of reporting a use permission notice (permitted) (step S2807).

After relay terminal 2700 reports the use permission notice (permitted) (step S2807), performs processing of providing nearby communication means information (step S2802), and processing of determining whether or not to relay communication (step S2803). If relay terminal 2700 relays communication, relay terminal 2700 relays communication (step S2805). If relay terminal 2700 does not relay communication, relay terminal 2700 does not perform processing. After relay terminal 2700 performs processing of reporting that relay is not possible (step S2808) after the processing of communication relay (step S2805), or when relay terminal 2700 does not relay communication, relay terminal 2700 issues a service termination request to other-carrier terminal management server 802 (step S2806).

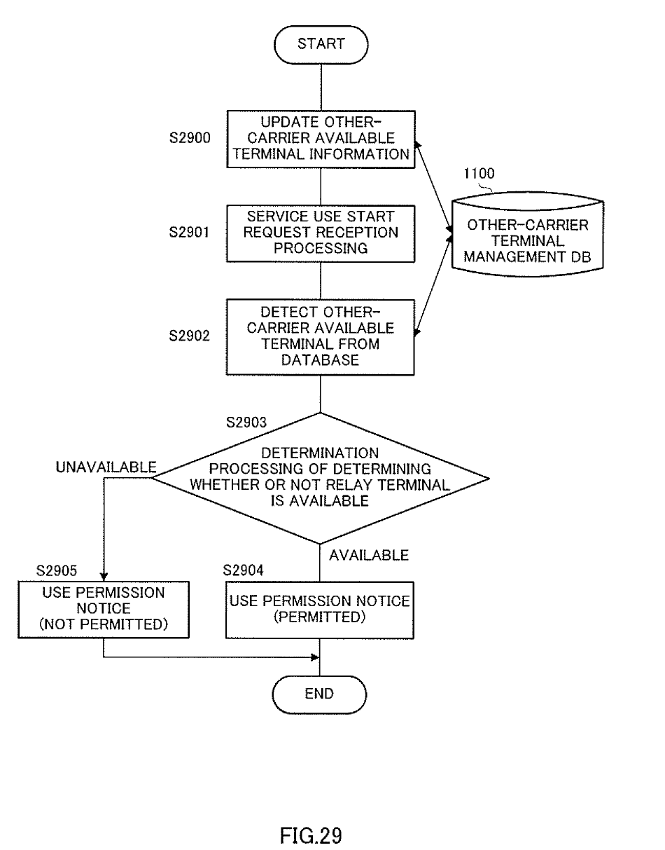

FIG. 29 is a flowchart showing a processing of other-carrier terminal management server 802.

In this figure, other-carrier terminal management server 802 performs processing of updating other-carrier available terminal information on other-carrier terminal management database 1100 (see FIG. 11) (step S2900). Next, other-carrier terminal management server 802 performs reception processing of a service use start request from relay terminal 2700 (step S2901). Then, other-carrier terminal management server 802 performs processing of detecting available mobile terminal from other-carrier terminal management database 1100 (step S2902).

Then, other-carrier terminal management server 802 performs determination processing of determining whether or not relay terminal 2700 is available (step S2903), and if relay terminal 2700 is not available, other-carrier terminal management server 802 issues a use permission notice (not permitted) (step S2905).

### If relay terminal 2700 is available, other-carrier terminal management server 802 issues a use permission notice (permitted) (step S2904) and finishes the processing.

Although cases have been described in embodiments of a service sequence, where mobile telephone 102 of the user is in the service area of a contracted carrier and where mobile telephone 102 of the user is outside the service area, the present invention is not limited to this, and the service can be provided by other sequences or flowcharts.

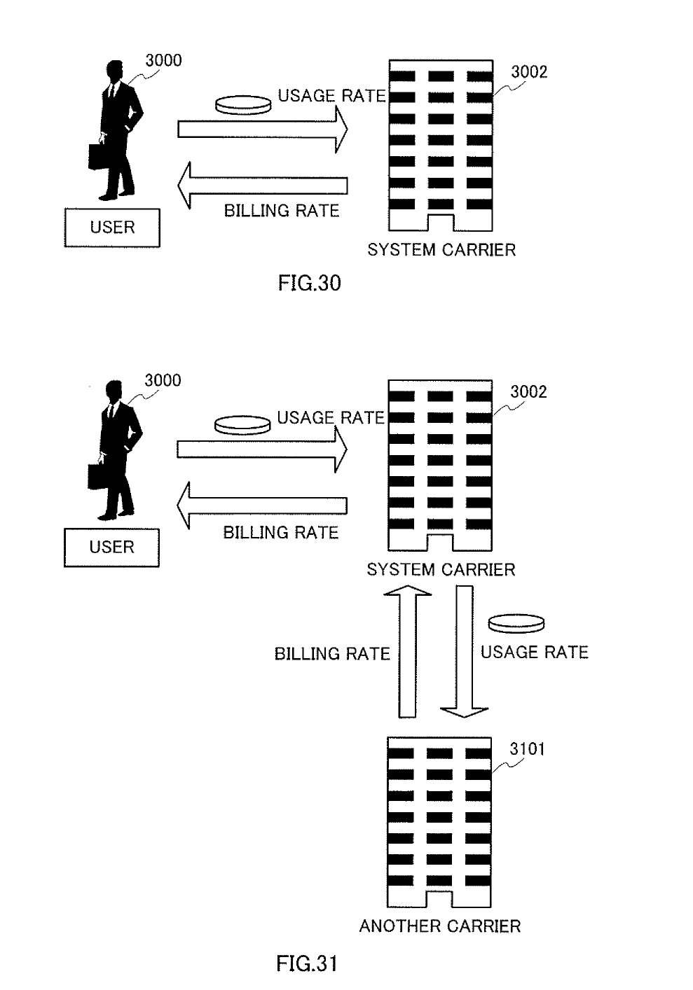

FIG. 30 illustrates a first usage fee payment method. In this figure, user 3000 receives a charging fee bill according to service use from system carrier 3002, and pays the usage fee to system carrier 3002.

FIG. 31 illustrates a second usage fee payment method.

In this figure, a charging fee bill is issued from another carrier 3101 to system carrier 3002. System carrier 3002 pays the usage fee to another carrier 3101 in response to the charging fee bill. System carrier 3002 issues a charging fee bill to user 3000, and user 3000 pays the usage fee to system carrier 3002.

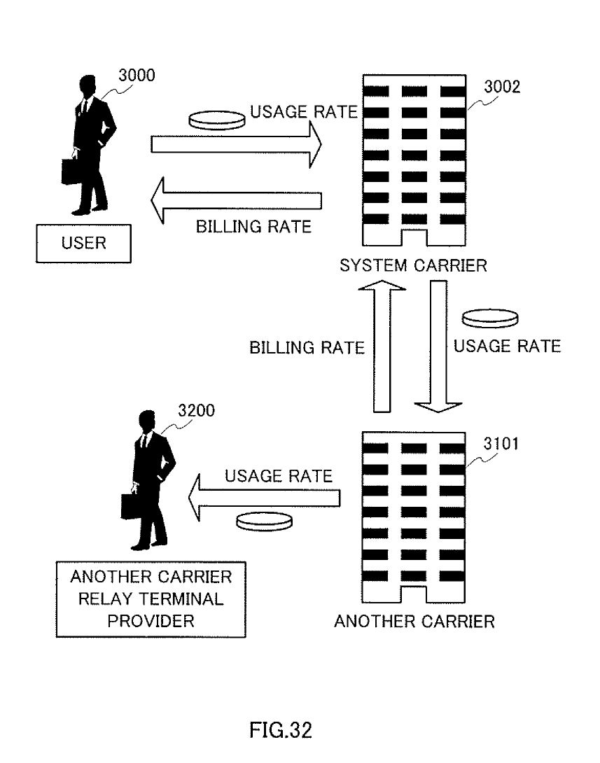

FIG. 32 illustrates a third usage fee payment method. In this figure, a charging fee bill is issued from another carrier 3101 to system carrier 3002. System carrier 3002 pays usage fee of another carrier 3101 in response to the charging fee bill. Then, system carrier 3002 issues a charging fee bill to user 3000, and user 3000 pays the usage fee to system carrier 3002. Another carrier 3101 pays terminal usage fee to another carrier relay terminal provider 3200.

In addition, the above described payment methods are examples, and other payment methods may be determined between the carrier and the user.

In this way, according to the mobile communication system of this embodiment, when there is a communication-possible range with a better condition than the communication-possible range of a communication carrier that currently provides a communication line to mobile telephone 102, the communication carrier that provides a communication line to the communication-possible range is selected to enable communication under management of this communication carrier so that it is possible to select a carrier or service area with a better condition than the currently used carrier or service area in terms of usage fee or service and achieve improvement of user convenience.

As described above, according to the present invention, when there is a communication-possible range with a better condition than the communication-possible range currently providing a communication line in the communication-possible range of the communication carrier, the communication-possible range with a better condition is selected to communicate so that it is possible to select a carrier or service area with a better condition than the currently used carrier or service area in terms of usage fee or service and achieve improvement of user convenience.

That is to say, (1) the mobile communication system of the present invention adopts a configuration having a mobile terminal and a management server apparatus that controls a base station communicating with the mobile terminal, wherein, when there is a communication-possible range with a better condition than the communication-possible range of a communication carrier that currently provides a communication line to the mobile terminal, the management server apparatus selects a communication carrier that provides a communication line to the communication-possible range, and, under management of this communication carrier, enables communication.

According to this configuration, if there is a communication line with a better condition than a current communication line, that communication line can be selected so that it is possible to select a carrier or service area with a better condition than the currently used carrier or service area in terms of usage fee or service and achieve improvement of user convenience.

(2) The mobile communication system of the present invention in the mobile communication system described in the above (1), adopts a configuration in which the management server apparatus controls a wireless LAN base station connected to a network, a base station connected via another network, or a terrestrial base station of an artificial satellite.

According to this configuration, the wireless LAN base station connected to the network, the base station connected via another network, or the terrestrial base station of the artificial satellite can be controlled so that it is possible to communicate using a communication line with a better condition than the current communication line in various locations.

(3) The mobile communication system of the present invention in the mobile communication system described in the above (1) or (2), adopts a configuration in which the mobile terminal has a communication carrier selection section whereby a user can arbitrarily select a communication carrier other than the contracted communication carrier, and, when a communication carrier is selected at the mobile terminal, the management server apparatus switches a communication line to the selected communication carrier.

According to this configuration, a mobile terminal user can select a desired communication carrier.

(4) The mobile communication system of the present invention in the mobile communication system described in any of the above (1) to (3), adopts a configuration in which the management server apparatus manages a mobile terminal of another communication carrier.

According to this configuration, the mobile terminal of another communication carrier is managed, and therefore it is possible to communicate with another mobile terminal.

(5) The mobile communication system of the present invention in the mobile communication system described in any of the above (1) to (4), adopts a configuration in which the management server apparatus manages charging information.

According to this configuration, the mobile terminal user managed in the management server apparatus can pay fee for communicating with a mobile terminal contracted with another communication carrier.

(6) The mobile communication system of the present invention in the mobile communication system described in the above (4) or (5), adopts a configuration in which the mobile terminal obtains information about another mobile terminal by control of the management server apparatus.

According to this configuration, it is possible to obtain information about another terminal at the mobile terminal managed by the management server apparatus.

(7) The mobile communication system of the present invention in the mobile communication system described in the above (6), adopts a configuration in which the mobile terminal reports the obtained information about another mobile terminal to the user.

According to this configuration, the mobile terminal user managed by the management server apparatus can check the information obtained from another mobile terminal.

(8) The mobile communication system of the present invention in the mobile communication system described in any of the above (4) to (7) adopts a configuration in which the mobile terminal obtains information about a remote mobile terminal via another mobile terminal different from the remote mobile terminal by control of the management server apparatus.

According to this configuration, the mobile terminal user managed by the management server apparatus can obtain information about the remote mobile terminal via another mobile terminal different from the remote mobile terminal.

(9) The mobile communication system of the present invention in the mobile communication system described in the above (4) to (8), adopts a configuration in which the mobile terminal communicates via another mobile terminal by control of the management server apparatus.

According to this configuration, the mobile terminal user managed by the management server apparatus can communicate with a remote mobile terminal via another mobile terminal different from the remote mobile terminal.

(10) A communication line switching method in a mobile communication system of the present invention is a communication line switching method in a mobile communication system that switches a communication line at a management server apparatus that controls a base station communicating with a mobile terminal, having, when there is a communication-possible range with a better condition than the communication-possible range of a communication carrier that provides the current communication line to the mobile terminal, selecting a communication carrier that provides the communication line to the communication-possible range, and, under management of this communication carrier, enabling communication.

According to this method, if there is a communication line with a better condition than the current communication line, that communication line can be selected so that it is possible to select a carrier or service area with a better condition than the currently used carrier or service area in terms of usage rate or service and achieve improvement of user convenience.

Therefore, the mobile communication system and the communication line switching method in the mobile communication system are suitable for application to a mobile communication system such as a mobile telephone system.

The present invention is not limited to the above described embodiments, and various variations and modifications may be possible without departing from the scope of the present invention.

This application is based on Japanese Patent Application No. 2005-025443 filed on Feb. 1, 2005, the entire content of which is expressly incorporated by reference herein.

What is claimed is;

1. A mobile communication system comprising a mobile terminal and a management server apparatus that controls a base station communicating with said mobile terminal,
wherein, when there is a communication-possible range with a better condition than the communication-possible range of a communication carrier that currently provides a communication line to said mobile terminal, said management server apparatus selects a communication carrier that provides a communication line to the communication-possible range, and, under management of said communication carrier, enables communication.

2. The mobile communication system according to claim 1, wherein said management server apparatus controls a wireless LAN base station connected to a network, a base station connected via another network, or a terrestrial base station of an artificial satellite.

3. The mobile communication system according to claim 1, wherein:
said mobile terminal comprises a communication carrier selection section whereby a user can arbitrarily select a communication carrier other than a contracted communication carrier; and
when a communication carrier is selected at said mobile terminal, said management server apparatus switches a communication line to the selected communication carrier.

4. The mobile communication system according to claim 1, wherein said management server apparatus manages a mobile terminal of another communication carrier.

5. The mobile communication system according to claim 1, wherein said management server apparatus manages charging information.

6. The mobile communication system according to claim 1, wherein said mobile terminal obtains information about another mobile terminal by control of said management server apparatus.

7. The mobile communication system according to claim 1, wherein said mobile terminal reports the obtained information about another mobile terminal to the user.

8. The mobile communication system according to claim 1, wherein said mobile terminal obtains information about a remote mobile terminal via another mobile terminal different from the remote mobile terminal by control of said management server apparatus.

9. The mobile communication system according to claim 1, wherein said mobile terminal communicates via another mobile terminal by control of said management server apparatus.

10. A communication line switching method in a mobile communication system that switches a communication line at a management server apparatus that controls a base station communicating with a mobile terminal, the communication line switching method comprising,
when there is a communication-possible range with a better condition than the communication-possible range of a communication carrier that currently provides a communication line to said mobile terminal, selecting a communication carrier that provides the communication line to the communication-possible range, and, under management of said communication carrier, enabling communication.
